(19) United States
(12) Patent Application Publication
(10) Pub. No.: US 2009/0071816 A1
(43) Pub. Date: Mar. 19, 2009

(54) Radio frequency plasma-water dissociator

(76) Inventor: Todd William Wallin, Pismo Beach, CA (US)

Correspondence Address: LAW OFFICES OF ANDREW SCHROEDER, P.O. Box 6731, Santa Maria, CA, 93454, US

(21) Appl. No.: 11/901,911

(22) Filed: Sep. 18, 2007

(51) Int. Cl. C01B 3/00; B01J 19/12

(52) U.S. Cl. 204/157.43; 422/186.29; 204/157.5

(57) ABSTRACT

A radio frequency plasma-water dissociator incorporates a plasma boiler, a RF Conduit, a dummy load, and a magnetron. The plasma boiler is in communication with the RF Conduit. The RF Conduit is in communication with the dummy load. And the dummy load is in communication with the magnetron. The magnetron is used for the purpose of generating the radio frequency waves.

### FIELD OF INVENTION

The present invention relates with environmentally friendly and sustainable energy, hydrogen, and steam producing systems and methods.

### BACKGROUND OF INVENTION

One of the overarching issues facing industrialized nations today is generating energy and power to meet all our needs efficiently without generating greenhouse gases. Many smokestack industries have been able to generate energy using relatively cost-effective means. However, these same industries also release so many greenhouse gases and other pollutants, many scientists are convinced that their entry into the Earth's atmosphere is contributing to the global warming effect. As a result of the substantial burden to Earth's atmosphere scientists predict dire consequences in climate changes throughout the world such as increased hurricanes, droughts, famines, and flooding.

To combat this trend many industries have turned to alternative fuels and other means of generating electricity. Although a substantial amount of progress has been made many of these technologies are still in their infancy and need more research and development in order to fully realize their potential.

One method of producing energy is through steam. The use of steam for the purpose of powering engines and other systems has been used for centuries. Although steam is a very expedient means of generating power, the production of steam requires vast amounts of energy, which are oftentimes generated in very inefficient ways.

Another method of producing energy is hydrogen. One of biggest challenges facing the new hydrogen economy is distribution and safety. It is expected to take several decades to build the infrastructure required to safely distribute hydrogen. Most hydrogen is produced by electrolysis. Electrolysis is a very inefficient method of hydrogen production requiring vast amounts of electricity for a minimal amount of hydrogen production. Nuclear power plants have been favored by scientist for producing hydrogen because of the benefits of vast amounts of hydrogen production utilizing fairly efficient nuclear reactions and producing hydrogen through a thermochemical reaction. Of course, with nuclear energy come the by-products of nuclear waste and safety issues.

Therefore, what are clearly needed in the marketplace are an apparatus, system, and means for the purpose of generating dissociated hydrogen through a thermochemical reaction. One additional benefit to this process is that the heat of the reaction can be used to produce superheated steam for the purpose of generating power. This system should be cost-effective, relatively free of pollutants, and use as little energy input as possible.

### SUMMARY OF THE INVENTION

It is an object of the present invention to provide a system, method, and apparatus to efficiently generate large amounts of usable energy with relatively inexpensive Radio Frequency Waves (hereafter “RF waves”). By incorporating the most recent technologies and research on plasma formation, the present invention can leverage relatively inexpensive RF Waves and the burning of dissociated water into vast quantities of hydrogen and steam without producing unwanted pollutants such as greenhouse gases or nuclear waste.

It is an object of the present invention to provide an energy efficient generator for the purpose of producing and supplying steam and/or heat to various reactors, heaters, turbines, or other apparatus which may utilize steam or heat as an energy source.

It is also an object of the present invention to produce and supply hydrogen. This produced hydrogen, in turn, may be used in conjunction with fuel cells, engines, and other apparatus which may utilize hydrogen as an energy source.

It is also an object of the present invention to provide a system, which can provide substantial cost savings in the generation of power using the latest research and technologies on plasmas. This, in turn can reduce the need for traditional smokestack processes, which introduce destructive greenhouse gases into the Earth's atmosphere.

It is also an object of the present invention to provide a hydrogen generator that can produce hydrogen on-demand using a very efficient thermochemical reaction without the by-product of nuclear waste. This thereby reduces the requirement for a completely new infrastructure for hydrogen distribution and storage.

It is also an object of the present invention to provide a potential plasma-boiler source for various mechanical processes in some industrialized operations. The present invention can be used in lieu of coal for many industrialized operations.

### BRIEF DESCRIPTION OF DRAWING FIGURES

FIG. 1 is a plan view of a preferred embodiment of the present invention.

FIG. 2 is a side view of a preferred embodiment of the present invention.

FIG. 3 is a side view of a preferred embodiment of the present invention.

FIG. 4 is a side view of a preferred embodiment of the present invention.

FIG. 5 is a side view of a preferred embodiment of the present invention.

FIG. 6 is a plan view of a preferred embodiment of the present invention.

FIG. 7 is a flow diagram of a preferred embodiment of the present invention.

FIG. 8 is a side view of a preferred embodiment of the present invention.

### DESCRIPTION OF PREFERRED EMBODIMENTS

According to a preferred embodiment of the present invention, a unique system, method, and apparatus are used to generate large amounts of hydrogen and steam for the purpose of powering various systems. The present invention operates largely through the process of thermochemical dissociation of water.

For the purposes of the present invention the term “plasma” shall mean an ionized gas or gaseous electric heat field.

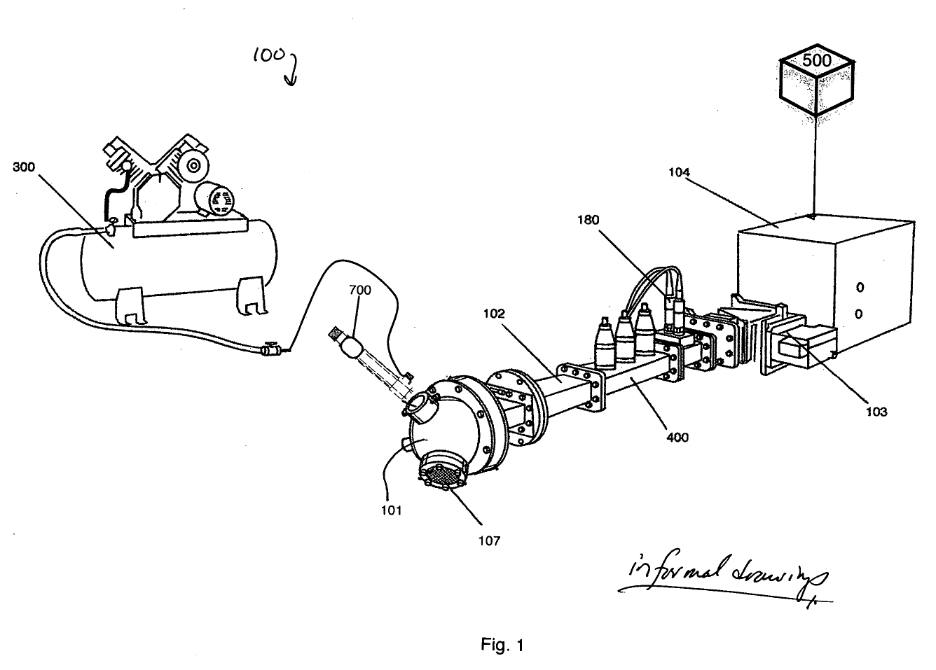

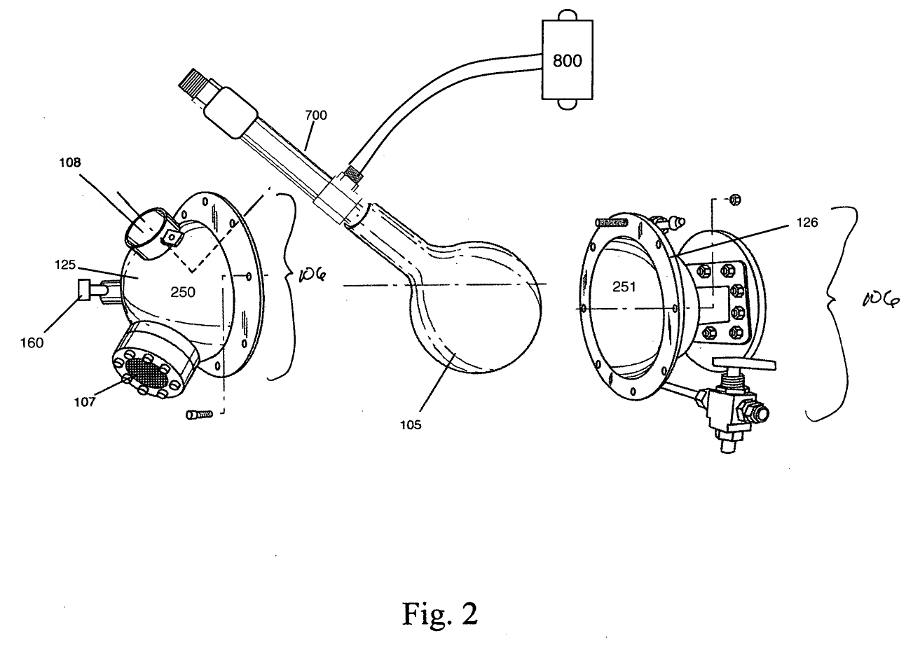

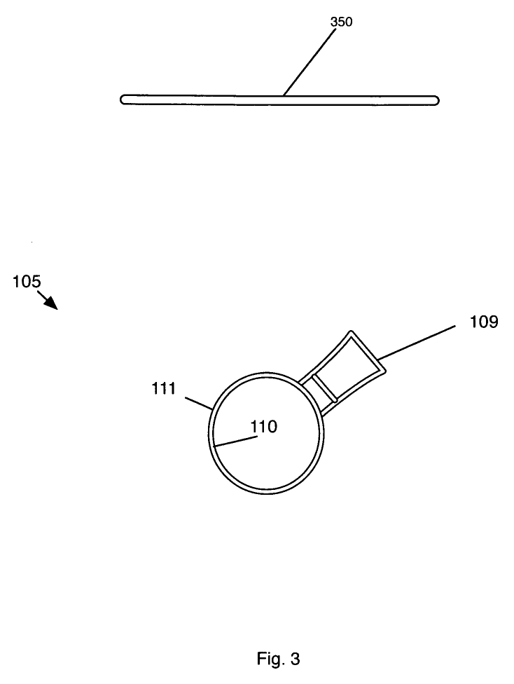

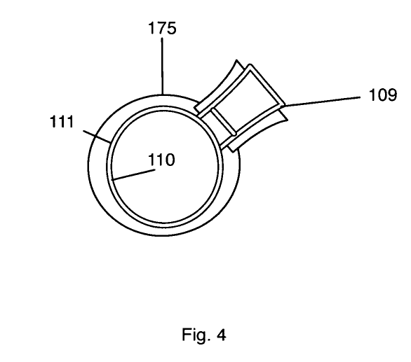

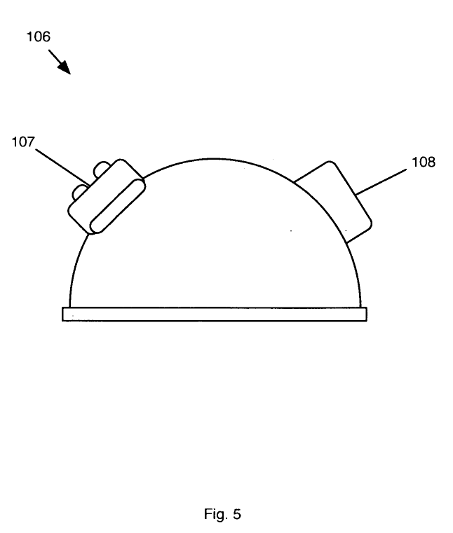

FIG. 1-3 illustrates a preferred embodiment of the present invention. An RF plasma water dissociator and plasma boiler 100 includes: a plasma boiler 101, an RF Conduit 102, a dummy load 103, and a magnetron 104. The magnetron is used for the purpose of generating RF Waves. It should be pointed out here that in some preferred embodiments the boiler may further comprise a gas separating membrane 800 (hereafter GSM). The purpose of the GSM is to filter out or separate out the Hydrogen. This is in communication with the plasma boiler as illustrated in FIG. 2.

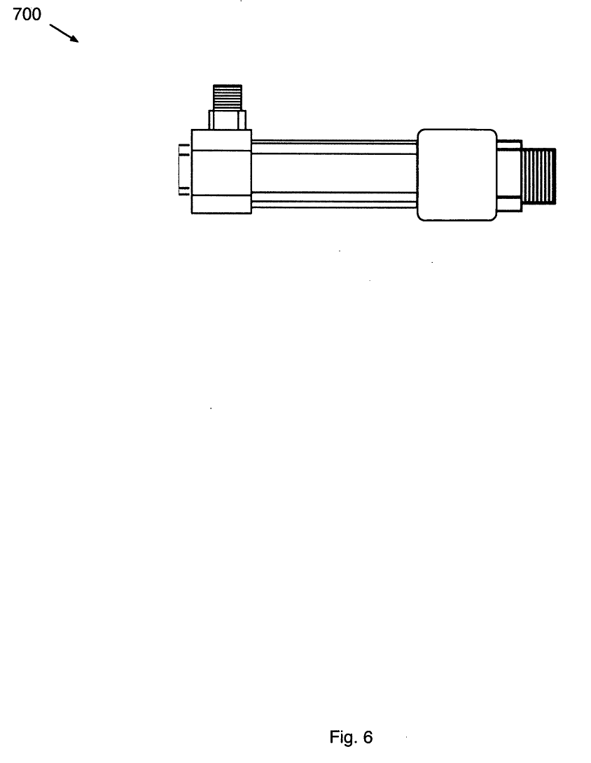

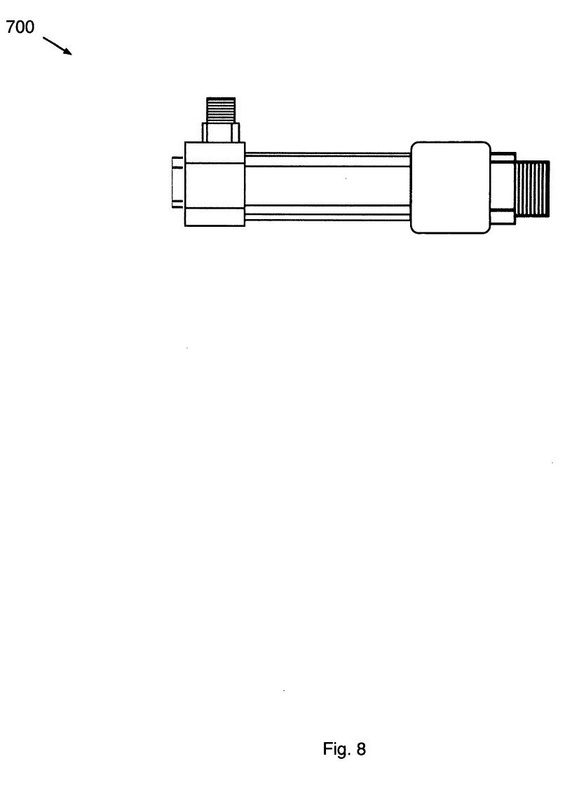

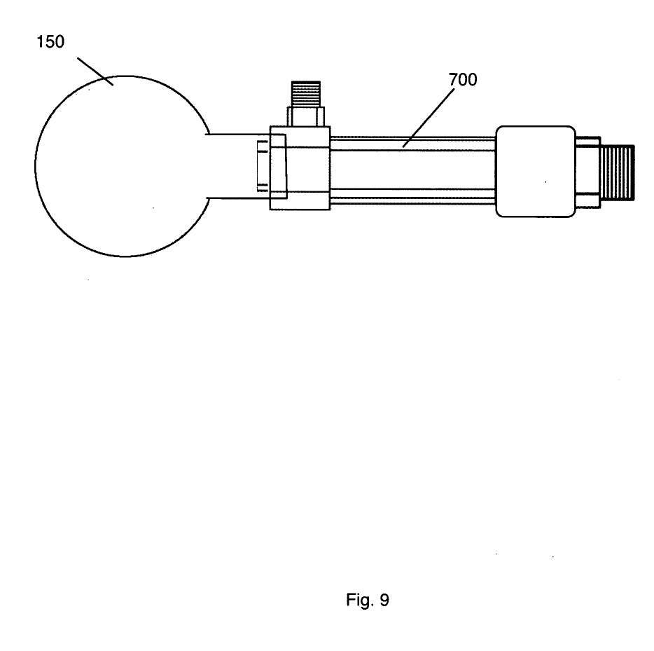

Also illustrated in FIG. 1, some preferred embodiments might also incorporate a cooling apparatus 500. The cooling apparatus is connected with the magnetron. In some preferred embodiments, the plasma boiler may further comprise a Ranque-Hilsch vortex-tube 700 as illustrated in FIGS. 6 and 8.

In some preferred embodiments the RF Conduit is a wave guide. One example of a wave guide, which may be used with the present invention, is the WR-284. The RF Conduit is simply a hollow tube used for channeling the RF Waves into the reaction chamber. Although wave guides are used in some preferred embodiments, the scope of the present invention should not be construed to utilizing only wave guides. Other apparatuses or conduits may prove to be equally expedient for the purposes of the present invention.

In some preferred embodiments the radio frequency used is a microwave of 2450 MHz. Although RF Waves of 2450 MHz are used in some preferred embodiments, the scope of the present invention should not be construed to utilizing only RF Waves of 2450 MHz. Other radio frequencies may prove to be equally expedient for the purposes of the present invention.

The function of the plasma boiler is plasma containment and water dissociation. The plasma boiler is comprised of the reaction chamber 105 and the reaction chamber housing 106. The reaction chamber is disposed within the reaction chamber housing 106.

The reaction chamber housing is comprised of an exhaust orifice 107 and a receiving orifice 108. In some preferred embodiments the reaction chamber housing may comprise a 1^{st} hemisphere 250 and a 2^{nd} hemisphere 251. Moreover, in some preferred embodiments the reaction chamber housing may further comprise a pressure relief valve 160. The purpose of the pressure relief valve is to allow pressure to release from the boiler.

The reaction chamber is housed within the reaction chamber housing. The reaction chamber includes one intake orifice 109, an inner surface 110 and an outer surface 111. In some preferred embodiments this reaction chamber may be a quartz beaker or any other microwave permeable material. The intake orifice is aligned with the receiving orifice of the reaction chamber housing.

The reaction chamber is the location where the plasma is generated. As RF Waves are emitted into the reaction chamber, a graphite member 350 is introduced into the reaction chamber. This graphite member acts to catalyze the plasma reaction. After the plasma is formed water is subsequently placed into the reaction chamber housing. The reaction chamber is the location where water dissociates into both Hydrogen and Oxygen.

The exterior of the reaction chamber containing the plasma reacts with the water, thereby producing flashed superheated steam contained between the interior of the reaction chamber housing and the exterior of the reaction chamber. The superheated steam acts as a cooling agent for the reaction chamber.

Subsequently, water is introduced into the reaction chamber where the plasma dissociates the water into hydrogen and oxygen. One liter of water will generate 1,220 liters of hydrogen and 622 liters of oxygen. This dissociated water is a fuel source for heating the chambers.

The resulting gas, comprised of hydrogen and oxygen, is rapidly cooled as it exits the reaction chamber by through the Ranque-Hilsch vortex-tube effect. The gas is then directed through a hydrogen-separating membrane for separation of the hydrogen. The hydrogen can then be used as a separate fuel source for use in a plant such as a co-generation power plant or a hydrogen fuel cell for an automobile.

FIG. 4 illustrates a preferred embodiment where the system where the vessel may further include an outer shell 175 for the purpose of housing the reaction chamber. The outer shell is sized to fit the reaction chamber and also a cavity of water for the purpose of cooling the plasma boiler and producing flashed superheated steam. In some preferred embodiments this outer shell may be comprised of aluminum, stainless steel, or any other metal or ceramic material.

The reaction chamber housing is affixed to the RF Conduit 102. The RF Conduit is affixed to the dummy load 103. The dummy load is affixed with the magnetron. The dummy load houses a pre-determined amount of water. The purpose of the dummy load is to shield the magnetron from RF Waves, which may bounce back, or reflect back from the vessel to the magnetron.

FIG. 1 illustrates that a related component in some preferred embodiments is a meter 180. This meter is used to measure or detect RF Waves, which may be reflected back in the direction of the magnetron. This meter may be used to “zero-out” any bounce back or reflection of the RF Waves from the vessel. The meter reads the RF Waves that are emitted towards the vessel with one reader. With the other reader, the meter displays whether there are any RF Waves reflecting back to the magnetron. Since any reflection back to the magnetron can create damage, it is important to monitor and properly contain the RF Waves.

FIG. 8 also illustrates that in some preferred embodiments the vessel may further comprise a compressed air apparatus 300. The compressed air apparatus is affixed with the plasma boiler for the purpose of injecting compressed air into the plasma boiler. The compressed air is also used to power the Ranque-Hilsch vortex tube for the purpose of cooling the hydrogen.

FIG. 1 also illustrates that in some preferred embodiments the vessel may further include a microwave tuner 400 for the purpose of modulating the RF Waves from the magnetron. By ensuring the wavelengths are in synchronous relationship with each other the process will operate with increased efficiency.

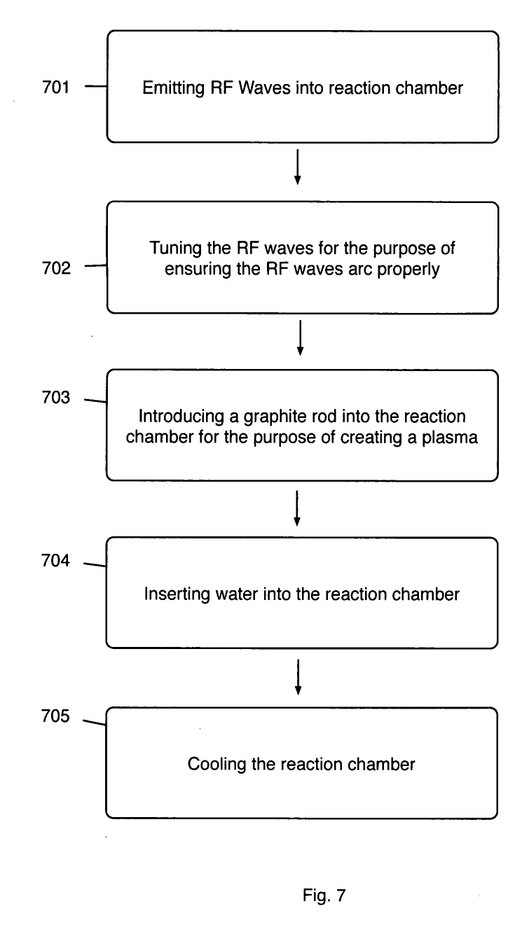

FIG. 7 illustrates a method to be used with the present invention. In step one 701 RF Waves are emitted into the reaction chamber. In step two 702 the RF Waves are tuned for the purpose of ensuring the RF Waves arc properly. In step three 703, a graphite member is introduced into the plasma boiler for the purpose of creating a plasma. In step four 704, water is introduced into the reaction chamber. And in step five 705, injecting air into the reaction chamber.

Those skilled in the art will appreciate numerous variations in the present system, configuration and operation that are within the scope of the invention. Those skilled in the art will also appreciate how the principles illustrated in these preferred embodiments can be used in other examples of the invention. A particular reference number in one figure refers to the same element in all of the other figures.

Moreover, it will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A radio frequency plasma-water dissociator comprising;
a plasma boiler, a RF Conduit, a dummy load, and a magnetron;
the plasma boiler is in communication with the RF Conduit;
the RF Conduit is in communication with the dummy load;
the dummy load is in communication with the magnetron.

2. The radio frequency plasma-water dissociator of claim 1 wherein the plasma boiler comprises a reaction chamber and a reaction chamber housing.

3. The radio frequency plasma-water dissociator of claim 1 further comprising a tuner for the purpose of modulating the RF Waves from the magnetron.

4. The radio frequency plasma-water dissociator of claim 1 further comprising a cooling apparatus; the cooling apparatus is in communication with the magnetron.

5. The radio frequency plasma-water dissociator of claim 1 further comprising a graphite member for the purpose of facilitating the plasma reaction.

6. The radio frequency plasma-water dissociator of claim 1 further comprising a Ranque-Hilsch vortex tube.

7. The radio frequency plasma-water dissociator of claim 1 wherein the RF Conduit is a wave guide.

8. The radio frequency plasma-water dissociator of claim 1 further comprising an outer shell for the purpose of housing the reaction chamber.

9. The radio frequency plasma-water based dissociator of claim 1 wherein the reaction chamber is a quartz beaker or any other microwave permeable material.

10. The radio frequency plasma-water based dissociator of claim 2 wherein the reaction chamber housing may be comprised of aluminum, stainless steel, or any other metal or ceramic material.

11. A method for generating hydrogen and steam comprising of the following steps:
a. emitting RF Waves into the reaction chamber;
b. tuning the RF Waves for the purpose of enabling the RF Waves to arc properly;
c. introducing water into the plasma boiler for the purpose of dissociating water into hydrogen and oxygen and heating the inner reaction chamber;

12. The method of claim 11 further comprising the step of placing a graphite member into the reaction chamber for the purpose of creating a plasma.

13. The method of claim 11 further comprising the step of injecting air or other gas or water into the reaction chamber housing for the purpose of cooling the reaction chamber and creating flashed superheated steam.

14. The method of claim 11 wherein the RF Waves are generated by a magnetron.

15. The method of claim 11 wherein the plasma boiler comprises a reaction chamber and a reaction chamber housing.

16. The method of claim 11 wherein the RF Waves are emitted into the plasma boiler through a wave guide.

17. The method of claim 11 wherein the RF Waves are emitted by a magnetron.

18. The method of claim 11 wherein the injected air into the cooling manifold is generated from a compressed air apparatus; the compressed air apparatus is connected to the Ranque-Hilsch vortex tube.

19. A radio frequency plasma-water dissociator comprising: a plasma boiler, a RF Conduit, a dummy load, and a magnetron for the purpose of generating RF Waves;
the plasma boiler is in communication with the RF Conduit;
the RF Conduit is in communication with the dummy load;
the dummy load is in communication with the magnetron the plasma boiler is comprised of a reaction chamber and a reaction chamber housing.

20. The radio frequency plasma-water dissociator of claim 19 further comprising an outer shell for the purpose of housing the reaction chamber; the outer boiler shell is sized to fit the reaction chamber.
